(19) United States
(12) Patent Application Publication
(10) Pub. No.: US 2025/0139568 A1
(43) Pub. Date: May 1, 2025

(54) DEMOGRAPHIC AND IDENTITY VERIFICATION FOR DELIVERY RESTRICTIONS

(71) Applicant: HOME VALET, INC., Vienna, VA (US)

(72) Inventors: John SIMMS, Vienna, VA (US); Jack SIMMS, Vienna, VA (US); Tim VANFOSSON, Vienna, VA (US)

(73) Assignee: HOME VALET, INC., Vienna, VA (US)

(21) Appl. No.: 18/726,041

(22) PCT Filed: Dec. 22, 2022
(86) PCT No.: PCT/US2022/053799

§ 371 Date: Jul. 1, 2024

Related U.S. Application Data
(60) Provisional application No. 63/294,657, filed on Dec. 29, 2021.

(51) Int. Cl. G06Q 10/0832; G07C 9/00; G07C 9/37

(52) U.S. Cl. CPC G06Q 10/0832; G07C 9/00896; G07C 9/37; G07C 2009/0092

(57) ABSTRACT

A method of securely storing an age-restricted or identity-restricted item and controlling a delivery box can be useful for enabling efficient and convenient delivery of the item. The delivery box can be controlled such that a locking mechanism unlocks the delivery box, in response to (i) a request from a delivery agent and (ii) reception of an unlock instruction from a server, the unlock instruction being generated independently of output from a biometric sensor. The delivery box can then be controlled such that the locking mechanism locks the delivery box after the delivery agent places the item inside the delivery box. Also, the delivery box can then be controlled such that the locking mechanism to unlock the delivery box, in response to the biometric sensor detecting that biometric data of a person attempting to access the delivery box matches biometric data of a pre-authorized person.

### CROSS-REFERENCE TO RELATED APPLICATIONS

The present application is a National Stage Application of PCT/US22/53799 filed on Dec. 22, 2022, which claims priority to U.S. Provisional Application No. 63/294,657, filed on Dec. 29, 2021, the contents of which are hereby incorporated by reference in their entirety.

### BACKGROUND

There exists a problem in the delivery market that prevents restricted items from being left without an identification check at the time of delivery. Examples of restricted items include alcohol, cannabis, pharmaceutical drugs, high-value goods, ammunition, and other products that require age and/or identity verification at the time of delivery. This causes inefficiencies in the last-mile delivery market that result in additional time spent on the porch, resulting in higher logistics costs. A secure parcel container that includes software that permits an owner-user to verify his or her age and/or identity would help alleviate this problem by giving the retailer and/or courier a legally proper way to delivery restricted items without risk of non-age-verified consumers accessing the restricted item.

### SUMMARY

In one embodiment, a method of securely storing an age-restricted item and controlling a delivery box can be useful for enabling efficient and convenient delivery of the age-restricted item. The delivery box can be controlled such that a locking mechanism unlocks the delivery box, in response to (i) a request from a delivery agent and (ii) reception of an unlock instruction from a server, the unlock instruction being generated independently of output from a biometric sensor. The delivery box can then be controlled such that the locking mechanism locks the delivery box after the delivery agent places the age-restricted item inside the delivery box. Also, the delivery box can then be controlled such that the locking mechanism to unlock the delivery box, in response to the biometric sensor detecting that biometric data of a person attempting to access the delivery box matches biometric data of a pre-authorized person.

The delivery agent can access the delivery box without interfacing with the biometric sensor.

The age-restricted item placed inside the delivery box by the delivery agent can be an alcohol product, a pharmaceutical product such as insulin, a cannabis product, or ammunition.

The delivery box may be permanently secured in place in an outdoor location.

The method may further include controlling an interior temperature of the delivery box to be at a predetermined temperature by activating a thermal control system integrated with the delivery box.

In another embodiment, a delivery box comprises an interior compartment configured to hold an item; an access door that is movable with respect to the interior compartment; a biometric sensor configured to capture biometric data from a person attempting to access the interior compartment, the biometric sensor being disposed on an exterior portion of the delivery box; a locking mechanism configured to lock the access door in place so as to securely enclose the interior compartment; a wireless communication circuit configured to transmit and receive signals wirelessly; and a processor programmed to: control the locking mechanism to unlock the access door, in response to (i) an electronically-transmitted request from a delivery agent and (ii) reception of an unlock instruction from a server, the unlock instruction being independent of output from the biometric sensor, and control the locking mechanism to unlock the access door, in response to the biometric sensor detecting that the biometric data of the person attempting to access the interior compartment matches biometric data of a pre-authorized person.

### BRIEF DESCRIPTION OF THE DRAWINGS

Aspects of the present disclosure are further described in the detailed description which follows in reference to the noted plurality of drawings by way of non-limiting examples of embodiments in which like reference numerals represent similar parts throughout the several views of the drawings.

FIG. 1 illustrates an exemplary embodiment of the secure temperature-controlled container with divider walls disposed inside thereof.

FIGS. 2A and 2B illustrate how at least one divider wall can be removed.

FIGS. 3A and 3B illustrate a thermal control system for the container.

FIGS. 4A-4C illustrate components integrated with the access door of the container.

FIG. 5 illustrates an exemplary configuration of hardware elements present in and forming the secure temperature-controlled container.

FIG. 6 illustrates an exemplary configuration of hardware elements present in a terminal device that is used for identity verification and communicating with the delivery box.

FIG. 7 illustrates an exemplary age and identity verification flowchart.

FIGS. 8A and 8B illustrate exemplary flowcharts for purchase and delivery of a restricted item.

### DETAILED DESCRIPTION

Exemplary embodiments are described herein with reference to block diagrams and flowchart illustrations of methods, apparatus (e.g., systems), and computer program products according to various aspects. It will be understood that each functional block of the block diagrams and the flowchart illustrations, and combinations of functional blocks in the block diagrams and flowchart illustrations, respectively, can be implemented by computer program instructions. These computer program instructions may be loaded onto any combination of general purpose computer, special purpose computer, or other programmable data processing apparatus to produce a machine, such that the instructions which execute on the computer or other programmable data processing apparatus create means for implementing the functions specified in the flowchart block or blocks.

These computer program instructions may also be stored in a computer-readable memory that can direct a computer or other programmable data processing apparatus to function in a particular manner. The computer program instructions may also be loaded onto a computer or other programmable data processing apparatus to cause a series of operational steps to be performed on the computer or other programmable apparatus to produce a computer-implemented process such that the instructions which execute on the computer or other programmable apparatus provide steps for implementing the functions specified in the flowchart block or blocks. The memory may be a non-volatile memory.

It should be appreciated that the particular implementations shown and described herein are illustrative of the disclosure and its best mode and are not intended to otherwise limit the scope of the present disclosure in any way. Indeed, for the sake of brevity, conventional data networking, application development and other functional aspects of the systems (and components of the individual operating components of the systems) may not be described in detail herein. Furthermore, the connecting lines shown in the various figures contained herein are intended to represent exemplary functional relationships and/or physical couplings between the various elements. It should be noted that many alternative or additional functional relationships or physical connections may be present in a practical electronic transaction system.

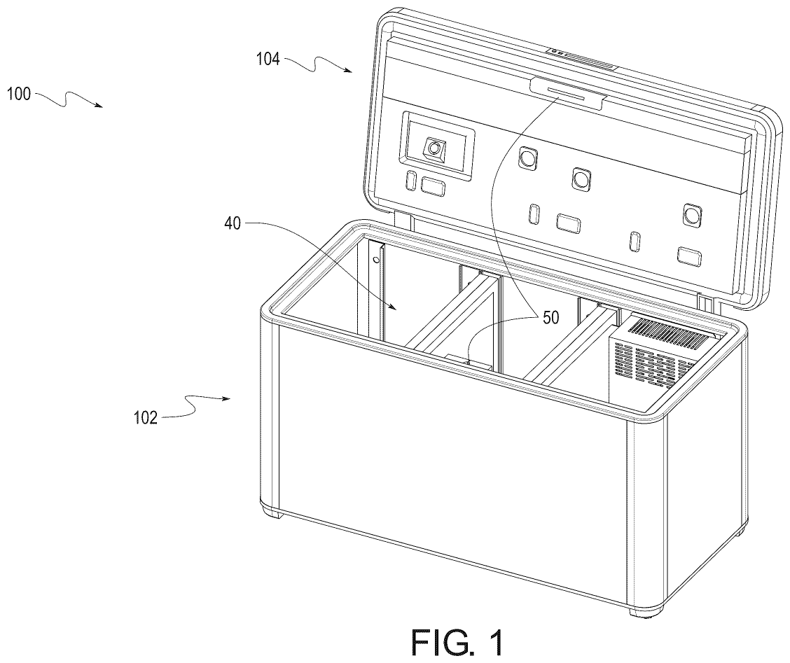

Referring to FIG. 1, embodiments of the present disclosure include a delivery box 100 for temporarily storing goods. In an exemplary embodiment, the delivery box 100 includes a container 102 connected to an access door 104 with a locking mechanism 50 associated therewith.

The access door 104 may be a hinged door and the access door 104 can be suitably locked by a variety of locking systems, such as an electromagnetic locking system, a key and lock system, an electronic coding device system, or any other locking mechanism. Electronically operated locks that can be controlled by software are particularly useful for the presently disclosed exemplary embodiments. The access door 104 may have a plurality of components discussed later herein for the purposes of climate control, monitoring items within the container 102, emergency unlock system, processing system, storing data, communications systems, etc. For example, the access door 104 may include one or more or all of the following: temperature sensors, humidity sensors, lights, UV LEDs, cameras, time of flight sensors for detecting divider placement, fans, batteries, transceivers, a microprocessor or a controller, memory (RAM, ROM, etc.), the locking system, a climate control system and/or any other component discussed herein. In one embodiment, all electronics of the delivery box are housed in the access door. In another embodiment, all electronics of the delivery box except for the climate control system are housed in the access door 104. It should be understood, that, in another embodiment, all of the electronics could be stored in the container 102. Regardless, the access door 104 is configured to be locked at all times when it is closed so that it is secure to the container so that the container 102 is not able to be accessed while the access door 104 is closed to the container 102. The access door 104 may be insulated and made of any suitable material to allow for security of the delivery box 100 and to allow for internal climate management of the delivery box 100.

As mentioned above, FIG. 1 illustrates that the access door 104 is hinged with the container 102. However, it should be understood that the access door 104 may be mechanically or electrically connected with the container 102 or other device in any suitable manner to allow the access door 104 to lock the access door 104 to the container 102. For example, the access door 104 could be slidably connected to the container 102.

The container 102 defines sidewalls that define an interior compartment 40 which may be completely enclosed when the access door 104 is closed. Also, this interior compartment 40 may be subdivided into zones using separation walls (referred to herein as “dividers”). The container 102 may include insulation material in the walls thereof to maintain the internal temperature of the contents inside the container.

The delivery box 100 may be any shape or size, constructed of any suitable material, such as, metal, plastic, wood and/or the like and include any number of compartments, openings and/or the like. That is, although FIG. 1 for example shows a container 102 with three compartments, the container could alternatively have two, four, five, or more compartments. The storage device may be free-standing or incorporated into any existing structure, device or element, such as, for example, the device may be integral with a bench, planter, statute, ground surface, wall and/or the like to prevent theft of the container. That is, the delivery box 100 can be permanently attached to a specific location so as to prevent the delivery box 100 from being easily carried away by an unauthorized person. Any portion of the delivery box 100 may be decorated, painted or designed to match the building facade or to imitate a structure or plant (e.g., to conform to area specific housing community guidelines). The delivery box 100 could have attached or enclosed within a thermal control system, including, for example, cooling means, heating means, humidity control means, and/or insulating means to maintain the compartment or sections thereof at a desired environment/climate in cases where the contents of the parcel contained climate/environment sensitive goods or perishable items, such as frozen foods or produce.

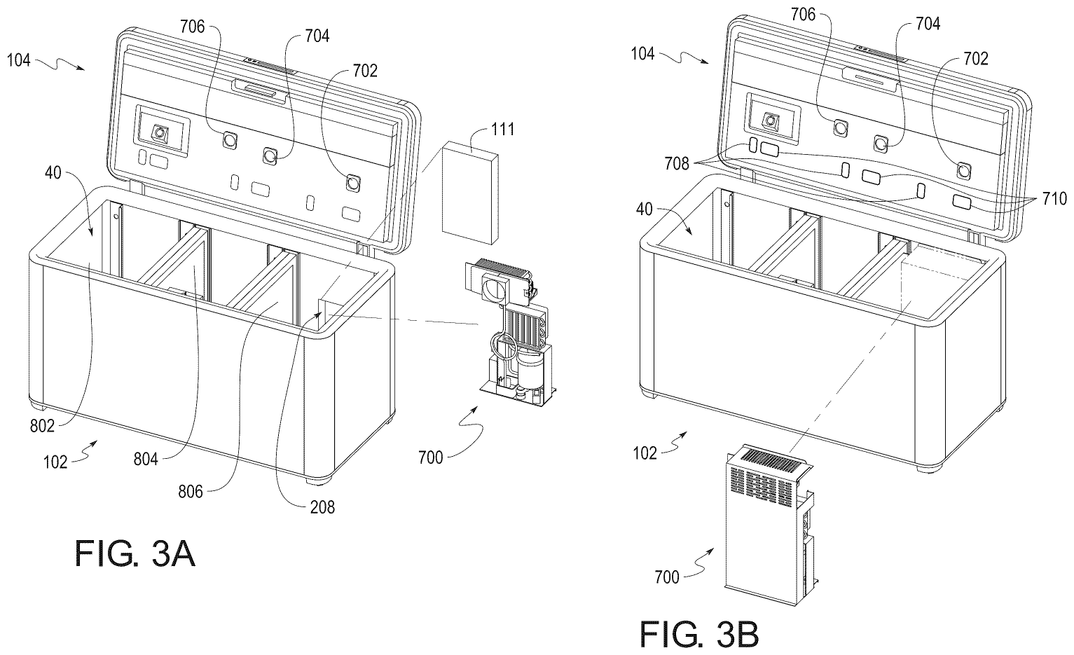

At least one of the side walls of the container 102 includes an access panel 111 (shown in FIG. 3A) which covers an access opening 208, where a thermal control system 700 can be accessed, inserted and/or removed when the access panel 111 is removed. For example, as shown in exemplary FIG. 3A, the access panel 111 can be a cutout portion of a rear panel of the container 102 such that when the access panel 111 is removed an access opening 208 is provided that is sized to be large enough that the thermal control system 700 can be accessed and/or accepted therethrough.

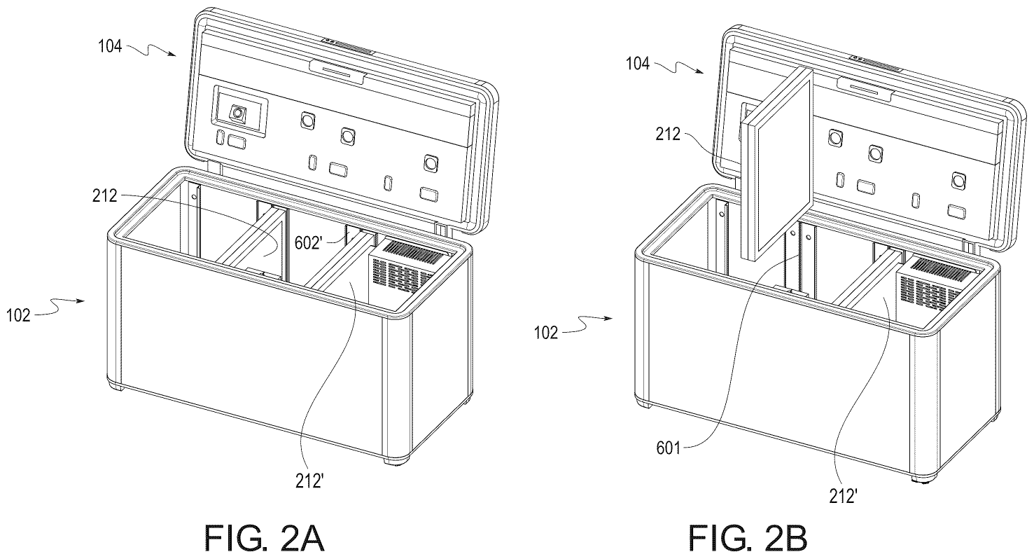

As shown in FIGS. 2A and 2B, the delivery box 100 may include dividers 212, 212′ that can be moved or removed. Although only one divider 212 is shown removed in FIG. 2B, both or all dividers can be removed. The dividers 212, 212′ may be different sizes for different sized packages or the dividers may be the same size. The dividers 212, 212′ may be used to divide a cooler into distinct zones for goods that may require separate temperature control (e.g. groceries, frozen food deliveries and the like), or any other desired storage compartment. In an alternative embodiment, the temporary storage device could be configured in a weather-proof or water resistant manner to temporarily protect the parcel from environmental elements or degradation. Moreover, the storage compartments may be easily removable or interchangeable to allow the user to select a preferred storage feature.

In one embodiment, the dividers 212, 212′ allow for different cooling zones to be defined within the container 102. For example, in the exemplary embodiment of FIG. 2A, the dividers 212, 212′ define three zones. The zones may include a freezer zone, a refrigeration zone, a heated zone, and/or a zone with no thermal cooling or heating (and the climate control is discussed later herein). The zones can be reconfigured when at least one divider is removed, moved, or added. That is, the freezer zone could expand when the divider 212′ is removed, or the refrigeration zone could expand when the divider 212′ is removed. The dividers 212, 212′ may be removably inserted into the container 102 using guide rails and can be secured into position by a rectangular-shaped frame which can be inserted over top of the dividers 212, 212′ once inserted. Each of the dividers 212, 212′ may be insulated in order to maintain the thermal zones to control the thermal environment of the zones. Additionally, the dividers 212, 212′ may allow for the humidity of each of the zones to be controlled so that different zones can have different humidity levels as controlled by the controller based on input from user interface.

It should be understood that the dividers 212, 212′ may be removed so that the box only has one large compartment. Also, there may be any number of dividers 212, 212′ and the disclosure is not limited in terms of the number of dividers 212, 212′. That is, while two dividers and three zones are illustrated in FIG. 2A, the container could include only a single divider with two zones, three dividers with four zones, or various other configurations.

FIGS. 3A and 3B illustrate a thermal control system 700 that is configured to be disposed within the interior compartment 40 of the container 102. The thermal control system 700 may include control electronics, a compressor, an evaporator, a condenser, an expansion valve, refrigerant fluid, a fan, and/or other components that may be used to generate cool or warm air. The thermal control system 700 is configured to be inserted into the compartment via an access opening 208 created by removing the access panel 111 of the rear side wall. The thermal control system 700 may also include a humidifier to be able to change the humidity of the air in the container 102; however, this humidifier may be a separate from the thermal control system 700.

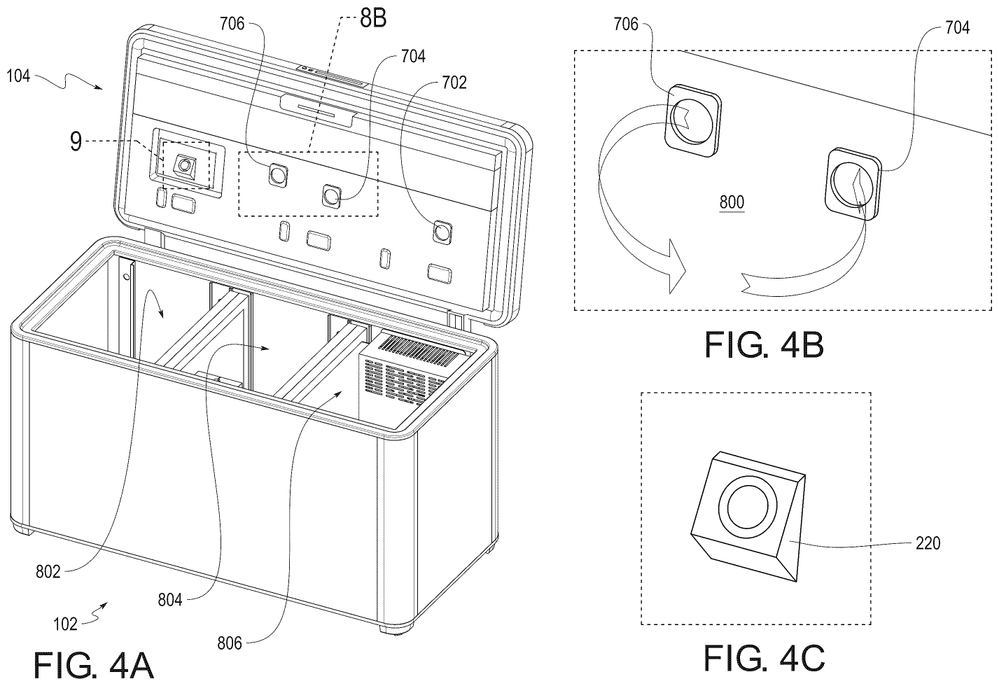

The access door 104 may include a series of temperature detectors 708 as well as lights 710 and/or UV LEDs. As shown in the exemplary embodiments of FIGS. 3A and 3B, the interior compartment 40 is split into three compartments 802, 804, and 806 (see also FIG. 4A) using dividers 212 and 212′, and there are three temperature detectors 708 and three lights 710—one for each divided compartment. In this regard, the temperature of each respective divided compartment 802, 804, and 806 can be independently monitored and each zone can be lit up using the lights 710 as desired. Moreover, it should be noted that the system may also include humidity sensors to monitor the level of humidity in each zone and report these measurements to the controller.

Also, the temperature of each individual divided compartment 802, 804, and 806 can be independently controlled as well, as is explained with reference to FIG. 4A below. It is noted that each of the compartments 802, 804, and 806 are divided so that air does not freely move between the compartments without the fans being activated (or ducts or dampers being activated), in some embodiments. In other embodiments, the compartments could not be completely divided so that some airflow can move between compartments but the airflow is limited due to the dividers.

In FIG. 4A, it is shown that there are multiple fans 702, 704, and 706 which regulate the air between zones. In this regard, the fans 702, 704, and 706 are controlled using a controller based on input by the user as to what each zone would be. The thermal control system shown in FIG. 3A could deliver cold or warm air to the different zones via the fans (and it is noted that the humidity of such air could be controlled as well using a humidifier). For example, FIG. 4A illustrates the thermal control system 700 is disposed in compartment 806. In this regard, compartment 806 can be a refrigerated compartment (based on the user setting this compartment as a refrigerated compartment).

In this same embodiment, compartment 804 could also be a refrigerated compartment and the fans 702 and 704 would be employed to move air between 804 and 806.

Moreover, even further in this same embodiment, compartment 802 could be not climate controlled. In this regards, the fan 706 would not operate in compartment 802 so that the cool air in compartments 804 and 806 stay in those compartments.

In this regard, the fans 702, 704, and 706 all work together to deliver air (either cooled or heated air) to the respective compartment. As shown in FIG. 4A, the fans 702, 704, and 706 may all be disposed in the access door 104 of the delivery box 100. However, the fans 702, 704, and 706 could be disposed in another other area of the delivery box 100.

For each compartment, the user could set the temperature to be at a specific predefined temperature (e.g., X degrees). If the temperature outside of the box is greater than the specific predefined temperature X degrees (e.g., in hot temperatures in the summer months) such that the temperature in a desired compartment is greater than the specific predefined temperature X degrees as detected by one of the temperature detectors, the controller would turn on the thermal control system 700 to generate air colder than the specific predefined temperature X degrees until the temperature in the desired zone is about the specific predefined temperature X degrees. The fan(s) would then turn on to deliver the cooled air to only the compartment where the temperate was higher than the specific predefined temperature (X degrees).

Also, if the temperature outside of the box is less than the specific predefined temperature X degrees such that the temperature in a desired compartment becomes less than the specific predefined temperature X degrees as detected by one of the temperature detectors (e.g., in freezing temperatures in the winter), the controller could turn on the thermal control system 700 in such a manner (e.g., reverse the compressor) to generate air warmer than the specific predefined temperature X degrees until the temperature in the desired zone is about the specific predefined temperature X degrees. The fan(s) would then turn on to deliver the heated air to only the compartment where the temperate was lower than the specific predefined temperature (X degrees). This can also be done using heater 800 that could be incorporated into the fan ductwork of the delivery box and controlled by the controller.

In this regard, in one embodiment, a heater 800 may be incorporated into the delivery box 100 to heat a particular zone requested by the user and controlled by the user. The heater could be located on the access door 104 or at the base of the delivery box 100. The location is not particularly limited.

The access door 104 may include an interior camera 220 as shown in FIG. 4C which is configured to view contents in the container 102 when the access door 104 is closed. The interior camera 220 would also be able to capture images when the access door 104 is opened, such as to be able to view a user accessing the container 102.

The delivery box 100 may be powered by electricity supplied by the home or business, its own integral power supply, as well as a battery back-up which may be used by the control unit to supply DC power to itself and to the input device and to the locking device should the AC power fail. That is, the container may include a standard 120V electrical connector (the connector/voltage may vary depending on the jurisdiction where the device is installed), and may additionally include a backup battery system to keep the contents cool if the power grid fails. The power supplied to the control unit may optionally be provided by solar power via a solar panel arranged on at least one side of the container 102.

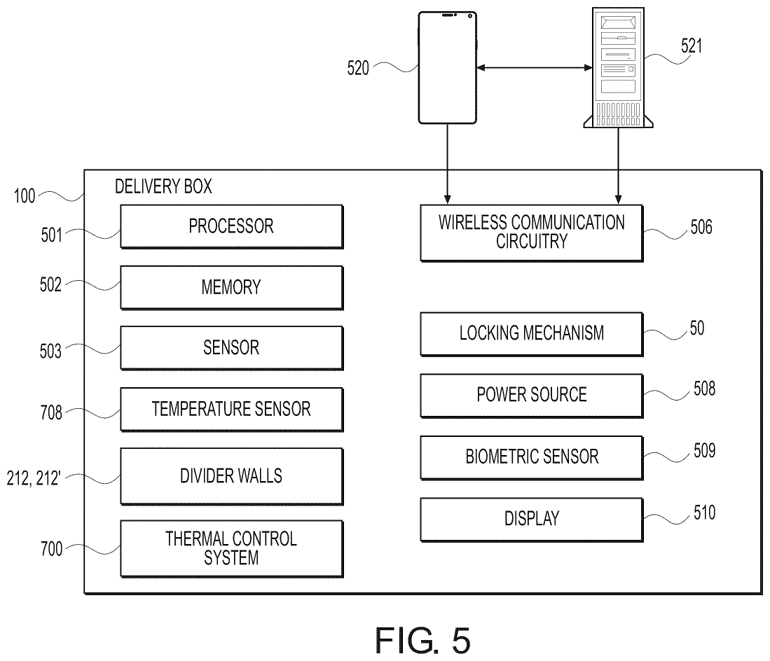

FIG. 5 illustrates a block diagram of certain components of the delivery box 100, which is a secure temperature-controlled container. The delivery box 100 includes a hardware-based processor 501 (i.e., a microcontroller) which controls the electronically operated components of the delivery box 100. A memory 502 which may be a non-volatile memory such as a flash drive or SSD is also included, and stores software-based instructions for controlling the delivery box 100. A volatile memory may also be included. The memory can also store biometric data of an authorized user so the processor can verify that an authorized person is attempting to access the box, and subsequently control the locking mechanism 50 to unlock.

A sensor 503, which may be a plurality of sensors, is also included and this sensor detects the configuration of the dividers 212 and 212′ inside the container 102. The sensor may be a time of flight sensor that generates an infrared or other radiofrequency signal, transmits the signal to the external environment, and measures how long the signal takes to return. The processor, by executing software stored in the memory, can then by referencing the time of flight return signal, determine which dividers (212, 212′) have been removed from the container, if any. The processor 501 could also determine that a divider has been moved from one position to another, and detect that a divider has been added using the same principle.

The sensor 503 may be located on the access door 104 at any position thereon as long as it can detect the dividers 212, 212′. However, the sensor 503 could conceivably be located in other positions instead of on the access door as long as it can accurately detect the presence/absence of the dividers 212, 212′.

The sensor 503 is not necessarily limited to a time of flight sensor. The sensor could also be a camera, a LIDAR sensor, or a sonar sensor. In such variations, these sensors would still detect whether dividers have been removed, moved, or added based on sensory output.

In another embodiment, the sensor 503 could be an electrical contact point (or multiple contact points) that would be used to determine which dividers are present or absent. In this embodiment, a divider (or each divider) would include at least one electrical contact point on a bottom or side portion thereof. The electrical contact, which may be metal, and could be a protrusion, a recess, or a flat portion, would close a switch arranged on the container 102 when the divider is placed in its proper position. The closed switch condition could then be detected by the processor 501 to determine that the divider is present in a location corresponding to the switch. The processor 501 could also determine that the divider is absent when the switch is open.

The dividers 212, 212′ are illustrated in FIGS. 2A and 2B. The divider walls may be made from a material such as plastic and are removable. As explained above, the container 102 may include one, two, three, or more dividers. The dividers in one embodiment are devoid of electronics because the electronics are disposed in other parts of delivery box 100.

The thermal control system is explained above. The thermal control system 700 may include electronics, a compressor, an evaporator, a condenser, refrigerant fluid, an expansion valve, a fan, and/or other components that may be used to generate cool or warm air.

Wireless communication circuitry 506 may be provided along with an antenna and/or transceiver. The wireless communication circuitry 506 may be configured to implement communication via Wi-Fi, LTE, 4G, 5G, Bluetooth, NFC, or other types of wireless communication. The wireless communication circuitry 506 may communicate with a terminal device 520 (which may be a smartphone), a delivery agent's smartphone or mobile electronic device, or a server 521 via the Internet. Of course, the user could also communicate with delivery box 100 via an electronic tablet, smartwatch, desktop computer, laptop, etc. by way of the wireless communication circuitry 506. The wireless communication circuitry 506 may also communicate with a smartphone or other electronic device directly via Bluetooth or NFC instead of routing communication through a server.

The locking mechanism 50 operates to mechanically lock the access door 104 to the container 102 to prevent unauthorized persons from accessing contents inside the container. The locking mechanism 50 may be electronically controlled by the processor 501.

The power source 508 may include a standard electrical cable that connects to a wall-based plug and receives AC power from the grid. The power source may also include power conversion circuitry for converting the AC power to DC power for electronic components such as the processor. The power source may also include a battery backup such as a lithium ion battery in addition to the standard power plug. Solar panels may also be included in addition to the two aforementioned power sources.

A biometric sensor 509 may also be included. The biometric sensor captures biometric data from a person who is attempting to access the delivery box 100 and obtain the goods stored therein. Thus, the biometric sensor may be disposed on the exterior of the delivery box 100 at any location that is user accessible such as the top or sides. The processor 501 may control the biometric sensor 509 and receive data generated by the biometric sensor, and subsequently process the biometric data to confirm the identity of the person attempting access. The biometric sensor 509 may be implemented as a camera that captures images of a user's face, so that the processor 501 can perform facial recognition. The biometric sensor could alternatively be a fingerprint sensor that scans a thumb or other finger of a user to perform identity verification. In detail, the fingerprint scanner could include an optical sensor, a capacitive sensor, or an ultrasonic sensor, any one of which can scan the finger and produce a digital image. The biometric sensor could also be a microphone that captures a user's voice pattern. That is, the captured facial image, the captured fingerprint, or the captured voice pattern can be compared to a pre-stored facial image, a pre-stored fingerprint/thumbprint, or a pre-stored voice pattern in order to verify a user's identity quickly and automatically. Other types of biometric identification, such as iris recognition or retinal scans could also conceivably be performed, as long as they can quickly and accurately identify a user. A combination of biometric ID methods can be implemented, such as the combination of facial recognition and fingerprint scanning: in this case there would be multiple biometric sensors.

A display 510 may also be included with the delivery box 100. The display may be disposed on the exterior of the delivery box 100 at any exterior location, such as on the access door 104, or on the side of the delivery box 100, and the display may display information regarding the contents of the delivery box 100 or instructions for how to access the delivery box 100. The display may display an access code screen whereby correct entry of the access code is required to access goods stored within the delivery box 100. The display could also display various other images such as an interior temperature reading and it may be implemented as a small LCD screen. In an alternative embodiment, the display may simply be an alphanumeric access code panel with physical buttons for entering digits or characters that permits a user to unlock the delivery box when the correct alphanumeric or numeric code is entered.

Although the processor 501 can locally process the output from the biometric sensor 509 so as to perform identity verification, the processor can also operate to send the data generated by the biometric sensor 509 to a cloud server, where the biometric data can be processed by the cloud server, and the cloud server verifies the identity, and transmits the results to the processor 501. That is, the identity verification can be performed locally on the delivery box 100 or remotely in the cloud server. The cloud server may be useful if the identity verification requires a relatively large degree of processing power that is difficult for the local processor 501 to handle.

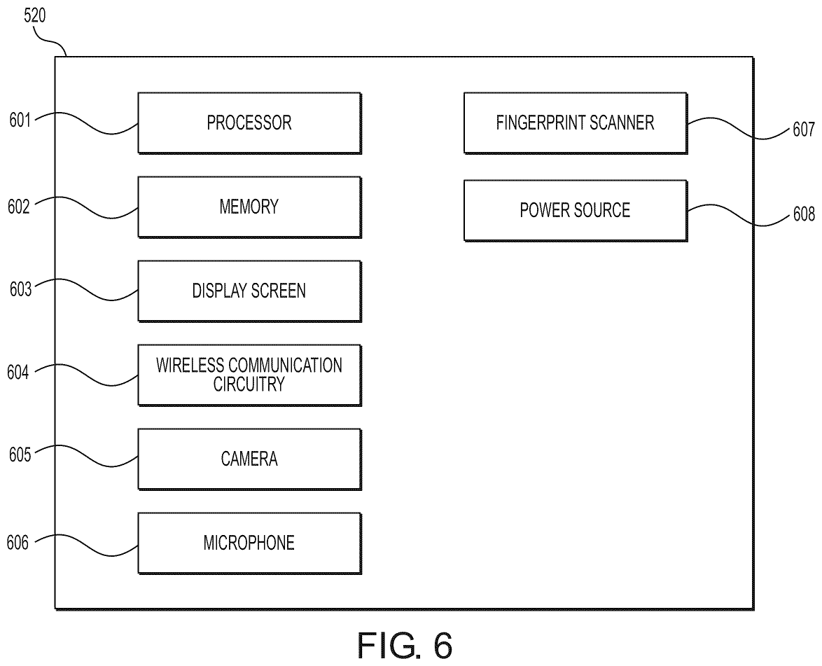

FIG. 6 illustrates a block diagram of certain components of the terminal device 520. The terminal device 520 may be a smartphone or an electronic tablet, but other electronic devices such as a laptop, a desktop computer, or a wearable electronic device could conceivably be used. The terminal device 520 includes a processor 601 that controls overall operations of the terminal device. A memory 602 is also included, which may comprise both a volatile memory such as DRAM and a separate storage that is non-volatile such as a flash drive or SSD. Programs executed by the processor 601 may be stored in the memory/storage 602. A display screen 603 is provided, which can display a graphical user interface (GUI) such as a GUI for verifying a user's identity. The display screen 603 may be a touchscreen so that no physical keyboard is required. The wireless communication circuitry 604 may be provided along with an antenna and/or transceiver. The wireless communication circuitry 604 may be configured to implement communication via Wi-Fi, LTE, 4G, 5G, Bluetooth, NFC, or other types of wireless communication. In particular, the wireless communication circuitry 604 can communicate with the delivery box 100 and/or a server 521. A camera 605 and a microphone 606 may be provided, and the camera can be disposed on the front user-facing portion of the terminal device to enable self-picture taking. A fingerprint scanner 607 is provided and could include an optical sensor, a capacitive sensor, or an ultrasonic sensor, any one of which can scan the finger and produce a digital image. The power source 608 may be a lithium-ion battery or power conversion circuitry that converts AC power from a wall socket to DC power suitable for the processor, memory, et cetera. The terminal device 520 may of course include additional mechanical or electrical components.

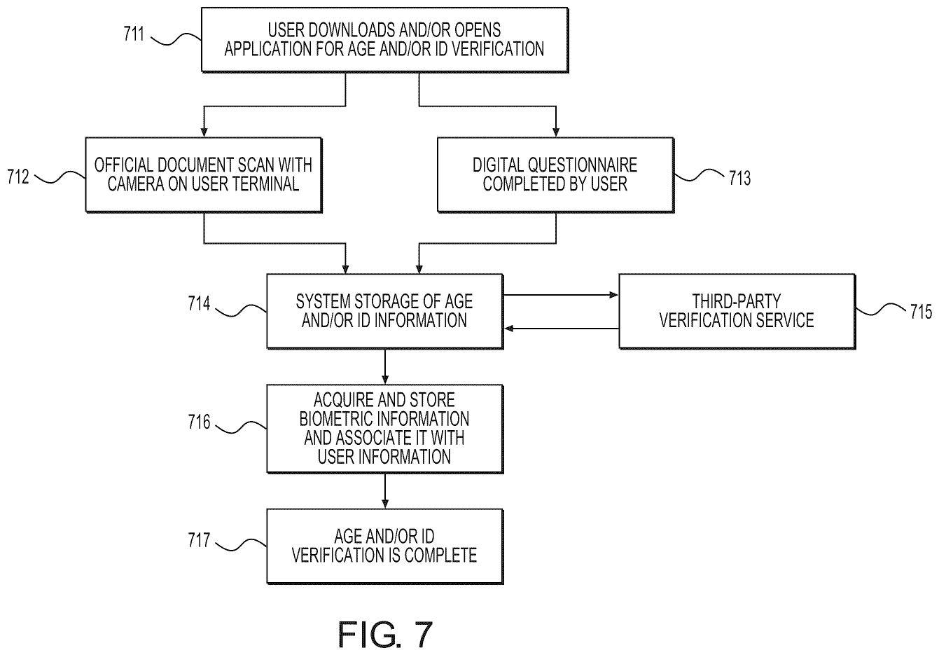

FIG. 7 illustrates a flowchart whereby a user's age and/or identity can be verified so that the user can purchase age-restricted items such as alcohol, cannabis, ammunition, or other restricted items and have the items be delivered to the delivery box 100 without the user being physically present at the time and place of delivery. Note that the item that is ordered can also be an identity-restricted item (rather than an age-restricted item) such as a prescription pharmaceutical drug. Insulin is one example of such a drug, but many other drugs require a prescription and can only be provided to the specific person who the prescription is written for.

Note that the delivery box 100 is typically secured in place outdoors permanently so that a courier can easily access it without entering the interior of the user's home. Since the delivery box 100 is outdoors, it is necessary to secure the box and prevent unauthorized persons from gaining access. For example, the delivery box could be permanently secured in place with a chain, with stakes driven into the ground that are attached to the box, or by attachment to a permanent structure such as brick wall.

At step 711, the user downloads an application (“app”) onto the terminal device 520, and subsequently opens the app. The user then creates an account associated with the app. The user could create a new username and a password to access the account, or the user could sign in with a third-party account that the user has previously created (i.e., sign in with APPLE®).

Once the user has downloaded the app and created an account, there are two ways to initiate age and/or ID verification. At step 712, the user could use the camera 605 integrated with the terminal device 520 to scan an official document such as a driver's license, a passport, a birth certificate, or some other document that provides clear evidence of the user's identity. Alternatively, the user could fill out a questionnaire whereby the user enters personal information, such as their name, date of birth or age, address, telephone number, driver's license number, et cetera. Of course, it is possible to include both steps 712 and 713 in the overall flow if both modes are desirable.

In an alternative embodiment, instead of scanning a driver's license at step 712, the user could instruct the app to access a mobile driver's license that is securely stored on the terminal device 520. The user information can then be pulled from the mobile driver's license.

At step 714, the app stores the user's age and/or identity information on the terminal device 520. It is preferable to store a plurality of data points for identity verification, such as at least the user's name, date of birth, current age, and address, but in some embodiments a more limited set of data points can be stored, such as only the user's name and age. The user's age and/or identity information can be encrypted and sent to a cloud server for long-term storage.

At step 715, which is optional, the user's identity information can be transmitted from the terminal device 520 to a third-party verification service in order to verify and authenticate the information that the user entered. The third-party verification service could subsequently transmit information indicating that the user's identity is verified. This step can be omitted when the other steps are sufficient for verifying identity. For example, if the user can demonstrate their identity with a high degree of confidence by scanning their driver's license and/or entering other personal information, the third-party verification may be unnecessary.

At step 716, which is optional, biometric information for the user can be acquired and stored. This biometric information can then be associated with the previously entered user information. For example, biometric information such as a facial image, a thumbprint or finger print, or a voice pattern could be stored. In detail, the user could take a picture of himself/herself with a camera 605 mounted on the terminal device 520, and this picture could be analyzed by the terminal device to determine a facial recognition pattern unique to the user. Alternatively, the user could scan a thumbprint or finger print using the fingerprint scanner 607, and the thumbprint/fingerprint can be stored for later comparison. Alternatively, the user could speak a predetermined phrase, and the microphone 606 of the terminal device could then acquire the spoken voice pattern and store it for later comparison. The biometric information can be encrypted and sent to a cloud server for long-term storage.

At step 717, the user's age and/or identity verification is complete. The user can then securely receive age-restricted items in the delivery box 100. The purchase and delivery flow will be described in detail subsequently, but in short the user will confirm his or her identity with the delivery box 100 after the restricted items are delivered into the delivery box 100, and after the delivery box 100 confirms that the person accessing the delivery box is the intended recipient, the delivery box 100 will grant access to the restricted items by unlocking itself via locking mechanism 50.

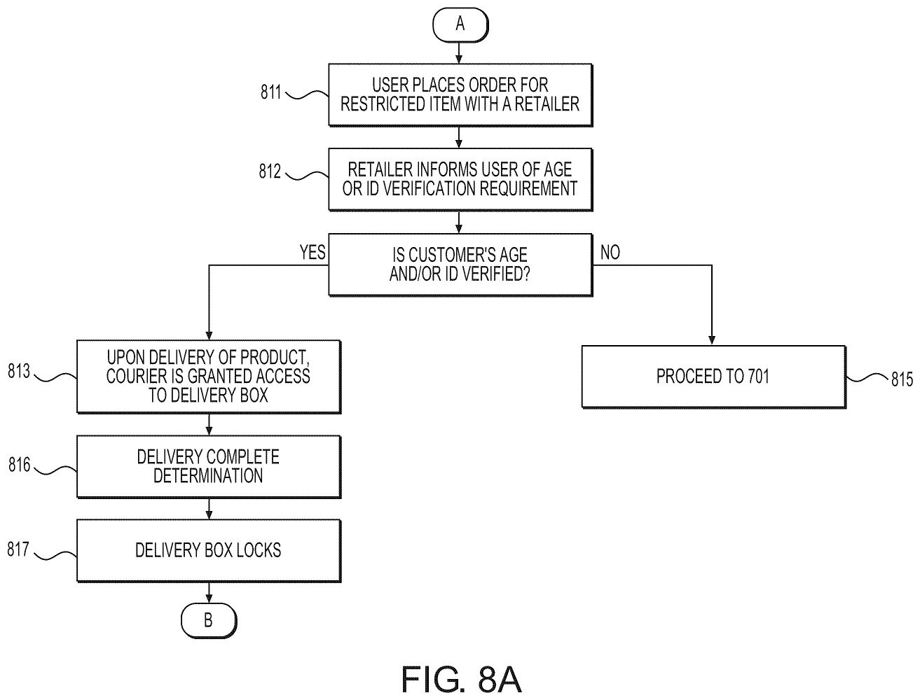

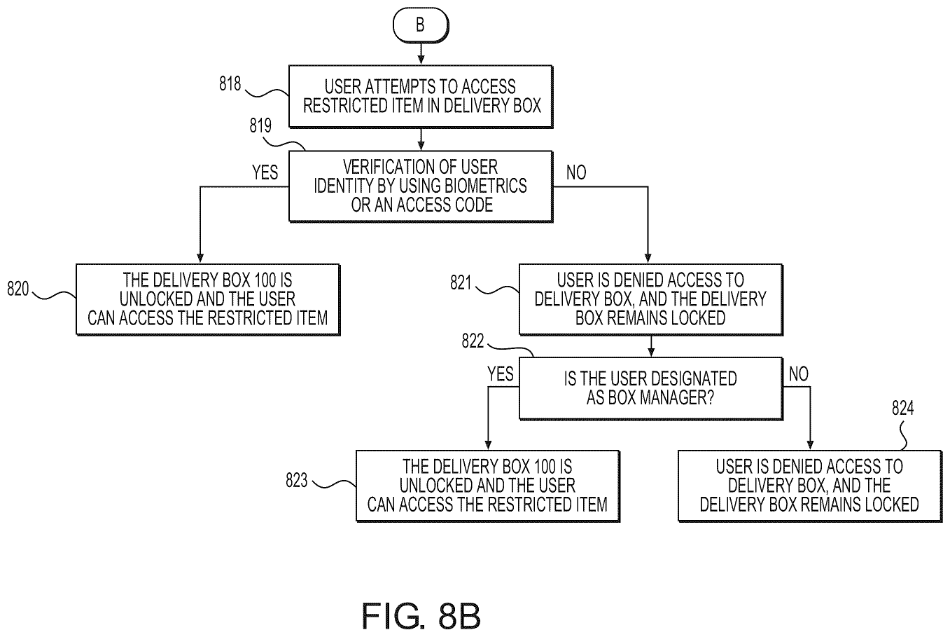

FIGS. 8A and 8B illustrate a flowchart for purchase and delivery of a restricted item. Note that some of these steps could be omitted in practice.

Referring to FIG. 8A, At step 811, the user places an order for a restricted item such as alcohol, cannabis, a prescription pharmaceutical drug, ammunition, et cetera that is prohibited from being sold to underage persons or unauthorized persons. The order is placed online via a website or an app for purchasing items.

At step 812, the retailer via the website or the app informs the user that age or ID must be verified to purchase and/or receive the restricted item. At step 813, a determination is made by the retailer as to whether or not the user who is purchasing the restricted item is age and/or ID verified.

At step 813 if the user is verified in this manner, the user can complete the purchase with the retailer, and access information can be transmitted from a server controlled by the retailer to a server controlled by the courier company or a mobile device used by the actual courier who delivers the item.

At step 814, the courier is granted access to the delivery box 100 so that the restricted item can be placed therein. For details of this process, see Applicant's prior disclosure in U.S. application Ser. No. 17/214,236, published as US 2021/0304539, which is hereby incorporated by reference in its entirety. In one example, the courier submits a request to access the delivery box on a mobile electronic device, the request is sent to a server, and after the server authenticates the request, the server can send an instruction to unlock the delivery box, which causes the processor 501 of the delivery box to unlock the locking mechanism. Subsequently, the courier/delivery agent can place the age-restricted item inside the delivery box. Note that the courier/delivery agent accesses the box without using any sort of biometric verification. In other words, the process for granting access to the courier/delivery agent is completely independent from the biometric verification process.

At step 815, if the user is not age and/or ID verified, the transaction cannot be completed with the retailer. The user is thus prompted to begin the process shown in FIG. 7 via a graphical user interface displayed on a screen of the terminal device 520 on which the user is using to attempt the purchase.

At step 816, after the courier successfully places the restricted item inside the delivery box 100, a notification may be sent the user via the terminal device 520.

At step 817, the delivery box 100 controls the locking mechanism 50 to activate so that the delivery box 100 is locked and unable to be accessed by unauthorized persons.

Referring to FIG. 8B, at step 818, after the delivery is complete and the delivery box 100 locks itself, the user will at some point attempt to open the delivery box 100 and obtain the restricted item stored therein.

At step 819, the user confirms his or her identity. This could be accomplished in several ways. Since the delivery box 100 includes a biometric sensor 509, this sensor can be a camera that is activated so as to scan the user's face in order to perform facial recognition. Alternatively, the biometric sensor 509 could be a fingerprint scanner that scans the user's finger. Alternatively, the biometric sensor could be a microphone that detects the user's voice pattern. Alternatively, a one-time access code could be sent via text message to a smartphone that is associated with the user, and subsequently the user can enter the one-time access code on the display 510 in order to gain access: this is somewhat similar to two-step verification in password security. In any case, step 819 involves confirming that the user attempting access is the authorized person with a high degree of confidence.

The verification at step 819 can be performed by comparing the biometric information received at the delivery box 100 with the biometric information stored in step 716 to confirm that both sets of biometric information are the same or so similar that it can be determined with a high degree of confidence that the user attempting access is the same person who registered. The comparison can be performed by the processor 501 in the delivery box, or a processor in a cloud server. If the cloud server performs the determination, the processor 501 in the delivery box can receive the biometric information, send it to the cloud server, and the cloud server then performs the comparison and sends the result to the delivery box along with instructions to either unlock the box or keep it locked.

In the embodiments described so far, the delivery box 100 includes a biometric sensor 509 integrated therewith as described above. In an alternative embodiment, the biometric sensor 509 can be omitted from the delivery box, and the user can perform biometric authentication using the smartphone 520 or another electronic device such as a desktop computer or a tablet. For example, after step 818, the user can approach the delivery box, open his/her smartphone, and capture biometric data of himself/herself, such as a facial image, a fingerprint scan, or a voiceprint. Then the biometric data can be transmitted from the smartphone to the delivery box. The transmission method could be NFC for example, but other techniques are possible such as transmission over Bluetooth, a 4G network or Wi-Fi network. An NFC reader could of course be disposed on the delivery box. The delivery box 100 can then perform processing to verify that the received biometric data matches pre-stored data of a person authorized to access the delivery box. The transmitted biometric data could be timestamped to ensure that it is recent and authentic. The processing could be performed locally on the delivery box, or by transmitting the received data to a cloud server, and receiving the verification from the cloud server. This configuration reduces the complexity and manufacturing costs for the delivery box 100 because the biometric sensor can be omitted from the delivery box 100 without sacrificing much functionality. To sum up, step 819 can be performed by using biometric sensor hardware on a smartphone rather than a biometric sensor included on the delivery box.

At step 820, the processor 501 controls the locking mechanism 50 to unlock once the user's identity is confirmed. The user is then able to access the restricted item.

On the other hand, if at step 821 the verification is unsuccessful, due to an unauthorized person attempting to gain access to the delivery box 100 and subsequently failing the biometric authentication, the processor 501 will not control the locking mechanism 50 to unlock and the restricted item remains held securely inside the delivery box 100.

At step 822, a determination is made as to whether the user requesting access has been designated as a box manager. The box manager is a person who has been previously age-verified or identity verified and has previously been granted permission to access the delivery box 100. For example, the person who purchased the delivery box 100 may be designated as box manager, and another person living in the same household who has not been previously been verified may require separate ID verification before accessing the delivery box 100. As another example, suppose the person who purchased the delivery box 100 is the box manager, and another person in the household orders a restricted item which is subsequently delivered to the delivery box 100. The box manager can access the restricted item inside the delivery box 100 even if he/she did not order the item because he/she manages the box. The designation of box manager can be performed via a setting on an application on the terminal device 520, and this designation can be stored on a cloud server so that when the box manager attempts to open the delivery box, the delivery box can confirm that the box manager is authorized for access by transmitting information and/or receiving information over the internet with respect to the cloud server.

At step 823, the box manager is granted access. At step 824, a person who is not the box manager and not ID verified for access is denied access and the delivery box remains locked.

With the above-described exemplary embodiments, a user can order restricted items over the Internet such as alcohol, cannabis, pharmaceutical drugs, ammunition, and other products that require age and/or identity verification at the time of delivery, and have a courier place the restricted items inside the delivery box 100, so the user does not have to be physically present when the courier arrives with the restricted items. Thus, the user can receive the restricted items when he/she is at the office, for example. Furthermore, the courier can deliver the restricted items more efficiently because the courier can leave the items inside the delivery box without meeting the recipient in person. Also, the delivery box locks the items inside after delivery, so unauthorized persons cannot access the items. Also, if the prescription pharmaceutical product requires refrigeration, the delivery box 100 can keep the product at an appropriate temperature for an extended period of time. Lastly, persons who attempt to access the restricted items inside the delivery box 100 are subject to age and/or ID verification so that only authorized persons can access the goods.

To provide a more concrete example, a user could order a bottle of wine over the internet. The courier will place the wine inside the delivery box 100 regardless of whether the user is present. The delivery box then locks itself and the box can activate the thermal control system 700 to chill the wine. The user can then verify his/her identify with a biometric scan. Then, the delivery box 100 unlocks and the user can access the wine. The courier does not have to physically hand the wine to the user or leave the wine in an unsecure outdoor location.

In another concrete example, a user could order prescription insulin over the internet. The courier will place the insulin inside the delivery box 100 regardless of whether the user is present. The delivery box then locks itself and the box can activate the thermal control system 700 to refrigerate the insulin at an appropriate temperature such as about 36-46 degrees F. The user can then verify his/her identify with a biometric scan. Then, the delivery box 100 unlocks and the user can access the insulin. The courier does not have to physically hand the insulin to the user or leave the insulin in an unsecure outdoor location that is excessively warm. This prevents insulin from being spoiled due to inappropriately high temperatures, and prevents authorized access to the insulin.

It is to be understood that while the invention is disclosed in certain forms and embodiments, it is not to be limited to the specific forms or embodiments or parts or methods described and shown herein. It will be apparent to those skilled in the art that various changes may be made without departing from the scope of the invention and the invention is not to be considered limited to what is shown in the drawings and described in the specification.

What is claimed is:

1. A method of securely storing an age-restricted or identity-restricted item and controlling a delivery box, the delivery box including a locking mechanism and a biometric sensor, the method comprising:
controlling the locking mechanism to unlock the delivery box, in response to (i) an electronically-transmitted request from a delivery agent and (ii) reception of an unlock instruction from a server, the unlock instruction being generated independently of output from the biometric sensor;
controlling the locking mechanism to lock the delivery box after the delivery agent places the age-restricted or identity-restricted item inside the delivery box; and
controlling the locking mechanism to unlock the delivery box, in response to the biometric sensor detecting that biometric data of a person attempting to access the delivery box matches biometric data of a pre-authorized person.

2. The method according to claim 1, wherein the delivery agent accesses the delivery box without interfacing with the biometric sensor.

3. The method according to claim 1, wherein the age-restricted or identity-restricted item placed inside the delivery box by the delivery agent is an alcohol product.

4. The method according to claim 1, wherein the age-restricted or identity-restricted item placed inside the delivery box by the delivery agent is a cannabis product.

5. The method according to claim 1, wherein the age-restricted or identity-restricted item placed inside the delivery box by the delivery agent is a prescription pharmaceutical product.

6. The method according to claim 1, wherein the age-restricted or identity-restricted item placed inside the delivery box by the delivery agent is ammunition.

7. The method according to claim 1, wherein the delivery box is permanently secured in place in an outdoor location.

8. The method according to claim 1, further comprising controlling an interior temperature of the delivery box to be at a predetermined temperature by activating a thermal control system integrated with the delivery box.

9. A delivery box comprising:
an interior compartment configured to hold an item;
an access door that is movable with respect to the interior compartment;
a biometric sensor configured to capture biometric data from a person attempting to access the interior compartment, the biometric sensor being disposed on an exterior portion of the delivery box;
a locking mechanism configured to lock the access door in place so as to securely enclose the interior compartment;
a wireless communication circuit configured to transmit and receive signals wirelessly; and
a processor programmed to:
control the locking mechanism to unlock the access door, in response to (i) an electronically-transmitted request from a delivery agent and (ii) reception of an unlock instruction from a server, the unlock instruction being independent of output from the biometric sensor, and
control the locking mechanism to unlock the access door, in response to the biometric sensor detecting that the biometric data of the person attempting to access the interior compartment matches biometric data of a pre-authorized person.

10. The delivery box according to claim 9, further comprising a thermal control system that is configured to maintain at least a portion of the interior compartment at a predetermined temperature.

11. The delivery box according to claim 9, wherein the biometric sensor is a camera, a fingerprint scanner, or a microphone.

12. The delivery box according to claim 9, wherein the processor controls the locking mechanism to lock the access door after the delivery agent places the item inside the interior compartment.

13. The delivery box according to claim 9, further comprising a storage that stores the biometric data of the pre-authorized person.

14. The delivery box according to claim 9, wherein the processor is programmed to transmit a delivery notification indicating that the item has been delivered to a terminal device of the pre-authorized person, after the request from the delivery agent causes the access door to be unlocked.

15. A method of securely storing an age-restricted or identity-restricted item and controlling a delivery box, the delivery box including a locking mechanism, the method comprising:
controlling the locking mechanism to unlock the delivery box, in response to (i) an electronically-transmitted request from a delivery agent and (ii) reception of an unlock instruction from a server, the unlock instruction being generated independently of output from a biometric sensor;
controlling the locking mechanism to lock the delivery box after the delivery agent places the age-restricted or identity-restricted item inside the delivery box; and
controlling the locking mechanism to unlock the delivery box, in response to the delivery box receiving biometric data from a person attempting to access the delivery box and the delivery box determining that the received biometric data corresponds to pre-stored biometric data of a pre-authorized person,
wherein the delivery box does not include a biometric sensor.
